(19) United States
(12) Patent Application Publication
(10) Pub. No.: US 2026/0288415 A1
(43) Pub. Date: Sep. 24, 2026

(54) DEVICE AND METHOD WITH MEMORY

(71) Applicants: Samsung Electronics Co., Ltd., Suwon-si (KR); UNIST (Ulsan National Institute of Science and Technology), Ulsan (KR)

(72) Inventors: Jongeun LEE, Ulsan (KR); Jaewoo PARK, Ulsan (KR); Minsang YU, Ulsan (KR); Tairali ASSYLBEKOV, Ulsan (KR)

(73) Assignees: Samsung Electronics Co., Ltd., Suwon-si (KR); UNIST (Ulsan National Institute of Science and Technology), Ulsan (KR)

(21) Appl. No.: 19/561,821

(22) Filed: Mar. 10, 2026

(30) Foreign Application Priority Data
Mar. 20, 2025 (KR) 10-2025-0036113

(51) Int. Cl. G06F 7/544; G06F 13/16; G06F 17/16

(52) U.S. Cl. CPC G06F 7/5443; G06F 13/1673; G06F 17/16

(57) ABSTRACT

A memory device includes a memory bank comprising a memory cell array, a memory controller, and an operator, wherein the operator comprises a multiply-accumulate (MAC) array configured to perform outer product and accumulation operations between column vectors of a first size including non-zero (NZ) values of a first input matrix and row vectors of a second size including NZ values of a second input matrix received from the memory cell array, an output buffer configured to store an operation result based on each column vector and row vector of the MAC array, wherein the output buffer has a predetermined tile size corresponding to the first size and the second size, and a vector register file configured to load the operation result from the output buffer and provide the operation result to the MAC array for performing an accumulation operation.

### CROSS-REFERENCE TO RELATED APPLICATIONS

This application claims the benefit under 35 USC § 119(a) of Korean Patent Application No. 10-2025-0036113, filed on Mar. 20, 2025 in the Korean Intellectual Property Office, the entire disclosure of which is incorporated herein by reference for all purposes.

### BACKGROUND

### 1. Field

The following description relates to a device and method with memory.

### 2. Description of Related Art

Neural networks are a subfield of machine learning models, and various methods are proposed to accelerate and simplify neural network operations such as a vector operation or a matrix operation.

A graph neural network (GNN) is a neural network that processes graph-structured data, and the GNN needs to efficiently process a sparse structure of a graph. A sparse matrix is a matrix that includes many elements corresponding to null values, that is, 0 values, and since the results of operations based on such sparse data are mostly 0, a sparse matrix product may be used to reduce unnecessary operations.

In the sparse matrix product, data reuse may be maximized to reduce memory access costs. For example, optimization methods of data reuse may include weight stationary, input stationary, or output stationary methods.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one or more general aspects, a memory device includes a memory bank comprising a memory cell array, a memory controller, and an operator, wherein the operator may include a multiply-accumulate (MAC) array configured to perform outer product and accumulation operations between column vectors of a first size including non-zero (NZ) values of a first input matrix and row vectors of a second size including NZ values of a second input matrix received from the memory cell array, an output buffer configured to store an operation result based on each column vector and row vector of the MAC array, wherein the output buffer has a predetermined tile size corresponding to the first size and the second size, and a vector register file configured to load the operation result from the output buffer and provide the operation result to the MAC array for performing an accumulation operation.

In response to an operation based on a first column vector among the column vectors of the first input matrix and a first row vector among the row vectors of the second input matrix being completed in the MAC array, a first operation result based on the first column vector and the first row vector may be stored in the output buffer, the MAC array may be configured to determine an outer product operation result by performing an outer product operation between a second column vector, other than the first column vector, among the column vectors of the first input matrix and a second row vector, other than the first row vector, among the row vectors of the second input matrix received from the memory cell array and determine a second operation result by performing an accumulation operation between the first operation result and the outer product operation result, wherein the first operation result is generated from the output buffer through the vector register file, and the output buffer may be configured to update the first operation result with the second operation result generated from the MAC array through the vector register file.

The operator may be configured to transmit, in response to receiving a first command from the memory controller based on completion of operations between the column vectors and the row vectors in the MAC array, an updated operation result of the predetermined tile size from the output buffer to the memory cell array.

The memory device may include a plurality of memory banks, a memory cell array of each of the plurality of memory banks may be configured to pre-store one of first submatrices generated by dividing the first input matrix by the first size in a row direction and one of second submatrices generated by dividing the second input matrix by the second size in a column direction, and the first submatrices of the first input matrix each may include the column vectors of the first size and the second submatrices of the second input matrix each may include the row vectors of the second size.

Each of the plurality of memory banks may be configured to perform operations in parallel to determine an updated operation result of the predetermined tile size between one of the first submatrices of the first size of the first input matrix and one of the second submatrices of the second size of the second input matrix.

A combination of updated operation results of the predetermined tile size determined in each of the plurality of memory banks may correspond to a final operation result between the first input matrix and the second input matrix.

The MAC array may be configured to broadcast an NZ value of each row of the column vector of the first size of the first input matrix to NZ values of the row vector of the second size of the second input matrix fixed at a MAC unit level to perform the outer product operation.

The memory cell array may be configured to store a portion of the first input matrix in a compressed sparse column (CSC) format and a portion of the second input matrix in a compressed sparse row (CSR) format.

The operator further may include a first pointer buffer configured to store a first pointer of the first input matrix received from the memory cell array, a second pointer buffer configured to store a second pointer of the second input matrix received from the memory cell array, a first index buffer configured to store a row index value including NZ values of the first input matrix received from the memory cell array based on the first pointer, a second index buffer configured to store a column index value including NZ values of the second input matrix received from the memory cell array based on the second pointer, and a value buffer configured to store NZ values of the first input matrix received from the memory cell array.

While the MAC array performs an operation based on a first column vector of the first size of the first input matrix and a first row vector of the second size of the second input matrix, the second index buffer may be configured to receive the column index value corresponding to a second row vector, different from the first row vector, of the second input matrix from the memory cell array.

In one or more general aspects, a method includes performing outer product and accumulation operations between column vectors of a first size including non-zero (NZ) values of a first input matrix and row vectors of a second size including NZ values of a second input matrix received from a memory cell array, storing an operation result based on each column vector and row vector of a multiply-accumulate (MAC) array in an output buffer, wherein the output buffer has a predetermined tile size corresponding to the first size and the second size, and loading the operation result from the output buffer to a vector register file and providing the operation result to the MAC array for performing an accumulation operation.

The performing of the outer product and accumulation operations between the column vectors of the first size including the NZ values of the first input matrix and the row vectors of the second size including the NZ values of the second input matrix received from the memory cell array may include performing an operation based on a first column vector among the column vectors of the first input matrix and a first row vector among the row vectors of the second input matrix by the MAC array, wherein a first operation result based on the first column vector and the first row vector is stored in the output buffer, determining, by the MAC array, an outer product operation result by performing an outer product operation between a second column vector, other than the first column vector, among the column vectors of the first input matrix and a second row vector, other than the first row vector, among the row vectors of the second input matrix received from the memory cell array, and determining, by the MAC array, a second operation result by performing an accumulation operation between the first operation result and the outer product operation result, wherein the first operation result is generated from the output buffer through the vector register file, and wherein the output buffer may be configured to update the first operation result with the second operation result generated from the MAC array through the vector register file.

The method may include, in response to receiving a first command from a memory controller based on completion of the operation between the column vectors and the row vectors in the MAC array, transmitting an updated operation result of the predetermined tile size from the output buffer to the memory cell array.

The method may include pre-storing, by a memory cell array of each of a plurality of memory banks, one of first submatrices generated by dividing the first input matrix by the first size in a row direction and one of second submatrices generated by dividing the second input matrix by the second size in a column direction, wherein the first submatrices of the first input matrix each may include the column vectors of the first size and the second submatrices of the second input matrix each may include the row vectors of the second size.

The method may include performing operations in parallel using each of the plurality of memory banks to determine an updated operation result of the predetermined tile size between one of the first submatrices of the first size of the first input matrix and one of the second submatrices of the second size of the second input matrix.

A combination of updated operation results of the predetermined tile size determined in each of the plurality of memory banks may correspond to a final operation result between the first input matrix and the second input matrix.

An NZ value of each row of the column vector of the first size of the first input matrix may be broadcasted to NZ values of the row vector of the second size of the second input matrix fixed at a MAC unit level by the MAC array to perform the outer product operation.

The method may include storing, using the memory cell array, a portion of the first input matrix in a compressed sparse column (CSC) format and a portion of the second input matrix in a compressed sparse row (CSR) format.

The method may include storing, using a first pointer buffer, a first pointer of the first input matrix received from the memory cell array, storing, using a second pointer buffer, a second pointer of the second input matrix received from the memory cell array, storing, using a first index buffer, a row index value including NZ values of the first input matrix received from the memory cell array based on the first pointer, storing, using a second index buffer, a column index value including NZ values of the second input matrix received from the memory cell array based on the second pointer, storing, using a value buffer, NZ values of the first input matrix received from the memory cell array, and while the MAC array performs an operation based on a first column vector of the first size of the first input matrix and a first row vector of the second size of the second input matrix, receiving the column index value corresponding to a second row vector, different from the first row vector, of the second input matrix from the memory cell array.

In one or more general aspects, a method includes generating first submatrices by dividing a first input matrix by a first size in a row direction, generating second submatrices by dividing a second input matrix by a second size in a column direction, performing, for each element of a column vector of a first submatrix of the first submatrices, a product operation between the element of the column vector and each element of a corresponding row vector of a second submatrix of the second submatrices, and based on results of the product operations, generating a final operation result by performing, for each of the first submatrices, outer product and accumulation operations between column vectors of the first submatrix and row vectors of each of the second submatrices.

Other features and aspects will be apparent from the following detailed description, the drawings, and the claims.

### BRIEF DESCRIPTION OF THE DRAWINGS

FIG. 1 illustrates an example of a memory device according to one or more embodiments.

FIG. 2 illustrates an example of a sparse matrix according to one or more embodiments.

FIGS. 3A and 3B each illustrate an example of a dataflow according to one or more embodiments.

FIG. 3C illustrates an example of a flexible hybrid dataflow (FHD) according to one or more embodiments.

FIG. 4 illustrates an example of a method of performing a matrix product operation for a defined tile size according to one or more embodiments.

FIG. 5 illustrates an example of an operation method of a memory device according to one or more embodiments.

FIG. 6 illustrates an example of an operation method of a memory device according to one or more embodiments.

FIG. 7 illustrates an example of a method of performing a multiply-accumulate (MAC) operation and receiving a column index value, in an overlapping manner according to one or more embodiments.

Throughout the drawings and the detailed description, unless otherwise described or provided, the same drawing reference numerals may be understood to refer to the same elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences within and/or of operations described herein are merely examples, and are not limited to those set forth herein, but may be changed as will be apparent after an understanding of the disclosure of this application, except for sequences within and/or of operations necessarily occurring in a certain order. As another example, the sequences of and/or within operations may be performed in parallel, except for at least a portion of sequences of and/or within operations necessarily occurring in an order, e.g., a certain order. Also, descriptions of features that are known after an understanding of the disclosure of this application may be omitted for increased clarity and conciseness.

Although terms such as “first,” “second,” and “third”, or A, B, (a), (b), and the like may be used herein to describe various members, components, regions, layers, or sections, these members, components, regions, layers, or sections are not to be limited by these terms. Each of these terminologies is not used to define an essence, order, or sequence of corresponding members, components, regions, layers, or sections, for example, but used merely to distinguish the corresponding members, components, regions, layers, or sections from other members, components, regions, layers, or sections. Thus, a first member, component, region, layer, or section referred to in the examples described herein may also be referred to as a second member, component, region, layer, or section without departing from the teachings of the examples.

Throughout the specification, when a component or element is described as being “on”, “connected to,” “coupled to,” or “joined to” another component, element, or layer it may be directly (e.g., in contact with the other component, element, or layer) “on”, “connected to,” “coupled to,” or “joined to” the other component, element, or layer or there may reasonably be one or more other components, elements, layers intervening therebetween. When a component, element, or layer is described as being “directly on”, “directly connected to,” “directly coupled to,” or “directly joined” to another component, element, or layer there can be no other components, elements, or layers intervening therebetween. Likewise, expressions, for example, “between” and “immediately between” and “adjacent to” and “immediately adjacent to” may also be construed as described in the foregoing.

The terminology used herein is for describing various examples only and is not to be used to limit the disclosure. The articles “a,” “an,” and “the” are intended to include the plural forms as well, unless the context clearly indicates otherwise. As non-limiting examples, terms “comprise” or “comprises,” “include” or “includes,” and “have” or “has” specify the presence of stated features, numbers, operations, members, elements, and/or combinations thereof, but do not preclude the presence or addition of one or more other features, numbers, operations, members, elements, and/or combinations thereof, or the alternate presence of an alternative stated features, numbers, operations, members, elements, and/or combinations thereof. Additionally, while one embodiment may set forth such terms “comprise” or “comprises,” “include” or “includes,” and “have” or “has” specify the presence of stated features, numbers, operations, members, elements, and/or combinations thereof, other embodiments may exist where one or more of the stated features, numbers, operations, members, elements, and/or combinations thereof are not present.

Unless otherwise defined, all terms, including technical and scientific terms, used herein have the same meaning as commonly understood by one of ordinary skill in the art to which the present disclosure pertains and specifically in the context on an understanding of the present disclosure. Terms, such as those defined in commonly used dictionaries, are to be interpreted as having a meaning that is consistent with their meaning in the context of and specifically in the context of the present disclosure, and are not to be construed to have an ideal or excessively formal meaning unless otherwise defined herein.

As used herein, the term “and/or” includes any one and any combination of any two or more of the associated listed items. The phrases “at least one of A, B, and C”, “at least one of A, B, or C”, and the like are intended to have disjunctive meanings, and these phrases “at least one of A, B, and C”, “at least one of A, B, or C” (e.g., each phrase may include any one of the respective items alone, all of the items listed together, and all possible combinations thereof), and the like also include examples where there may be one or more of each of A, B, and/or C (e.g., any combination of one or more of each of A, B, and C), unless the corresponding description and embodiment necessitates such listings (e.g., “at least one of A, B, and C”) to be interpreted to have a conjunctive meaning.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application. The use of the term “may” herein with respect to an example or embodiment (e.g., as to what an example or embodiment may include or implement) means that at least one example or embodiment exists where such a feature is included or implemented, while all examples are not limited thereto. The use of the terms “example”, “embodiment”, and “example embodiment” herein have a same meaning (e.g., the phrasing ‘in an or one example’ has a same meaning as ‘in an or one embodiment” and ‘in an or one example embodiment’), and “one or more examples” has a same meaning as “one or more embodiments” and “one or more example embodiments”. Still further, each of multiple or all separately described an/one “example”, “embodiment”, “example embodiment”, as well as “examples”, “embodiments”, “example embodiments”, herein may be included, in combination, in a same embodiment in any combination.

Hereinafter, the examples are described in detail with reference to the accompanying drawings. When describing the examples with reference to the accompanying drawings, like reference numerals refer to like components and a repeated description related thereto will be omitted.

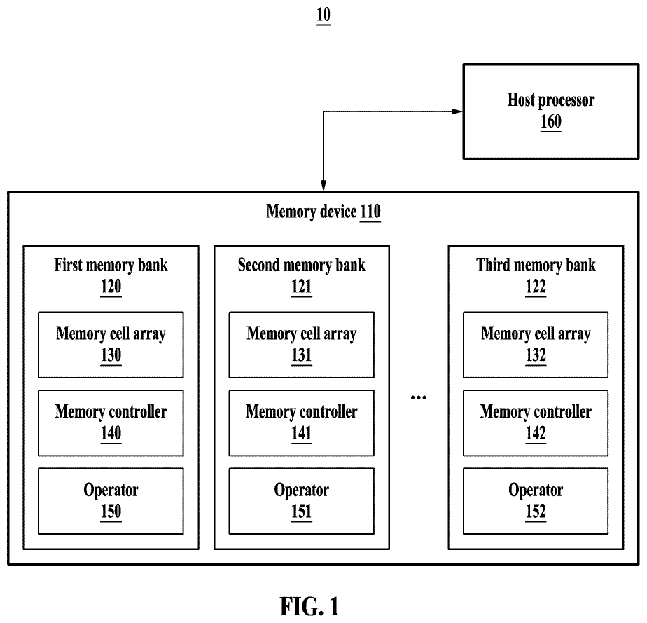

FIG. 1 illustrates an example of a memory device according to one or more embodiments.

A memory system 10 according to an example may be a processing-in-memory (PIM) system.

A memory device 110 may accelerate a sparse matrix operation and particularly, may accelerate a product operation between sparse matrices. The memory system 10 including the memory device 110 may be applied to artificial intelligence (AI) and high-performance computing (HPC) applications, and for example, the memory system 10 may be applied to servers and mobile devices.

The memory system 10 may support additional computing resources to be integrated into the memory device 110. The memory system 10 may include the memory device 110 connected to a host processor 160 (e.g., one or more processors), such as a graphics processing unit (GPU) and/or a central processing unit (CPU).

The host processor 160 may include a host memory controller (or a host controller) for interfacing with the memory device 110. However, the present disclosure is not limited thereto. For example, the host memory controller may be separated from the host processor 160 as a separate die or within the same die.

The memory device 110 may include a plurality of memory banks within a memory die. For example, the memory device 110 may include a first memory bank 120, a second memory bank 121, and a third memory bank 122. The number of memory banks included in the memory device 110 is not limited to the illustrated example. For example, the memory device 110 may include “16, 32 or 64” memory banks.

The host memory controller may be configured to control execution of instructions from the host processor 160. The instructions may include regular commands (or commands) and PIM commands altogether. For example, the regular commands (e.g., traditional load (read), store (write), and activate (ACT) functions that are not in-memory function commands) may be transmitted by the host memory controller and may be executed in a typical method.

For example, the regular commands may include a command to store data received through an external bus in the memory die and a command to search for and transmit data from the memory die to the host processor 160 through the external bus.

Aspects of the present disclosure relate to the use of in-memory computing, and the memory banks (e.g., the first memory bank 120, the second memory bank 121, and the third memory bank 122) may each include a memory cell array.

Referring to FIG. 1, the first memory bank 120 may include a memory cell array 130, a memory controller 140, and an operator 150. The second memory bank 121 may include a memory cell array 131, a memory controller 141, and an operator 151. The third memory bank 122 may include a memory cell array 132, a memory controller 142, and an operator 152. In non-limiting examples, the operators 150, 152, and 152 may each be a processor, a hardware accelerator, a neural processor, and/or a neural processing unit (NPU). In non-limiting examples, the memory controllers 140, 141, and 142 may each be a hardware circuit, a memory chip controller (MCC), a memory controller unit (MCU), and/or an integrated memory controller (IMC).

The memory banks (e.g., the first memory bank 120, the second memory bank 121, and the third memory bank 122) may each include the memory cell arrays 130, 131, and 132 arranged in rows and columns (or pages and columns). The memory banks (e.g., the first memory bank 120, the second memory bank 121, and the third memory bank 122) may each include dynamic random-access memory (DRAM) cells arranged in “n” rows (or pages) and “m” columns (here, n and m are natural numbers). A plurality of bit-lines of the memory cell arrays 130, 131, and 132 may extend along a column direction, and a plurality of row enable lines may extend along a row direction and may cross the bit-lines. Each bit-line may be connected to all memory cells in a corresponding column. Similarly, each row enable line may be connected to each memory cell in a corresponding row.

Since the memory banks of the memory device 110 respectively include the memory controllers 140, 141, and 142 and the operators 150, 151, and 152, independent data access and parallelization of operations may be implemented within each memory bank.

The memory controllers 140, 141, and 142 may control transmission and reception of data between the memory cell arrays 130, 131, and 132 and the operators 150, 151, and 152 by generating a command (e.g., read or write).

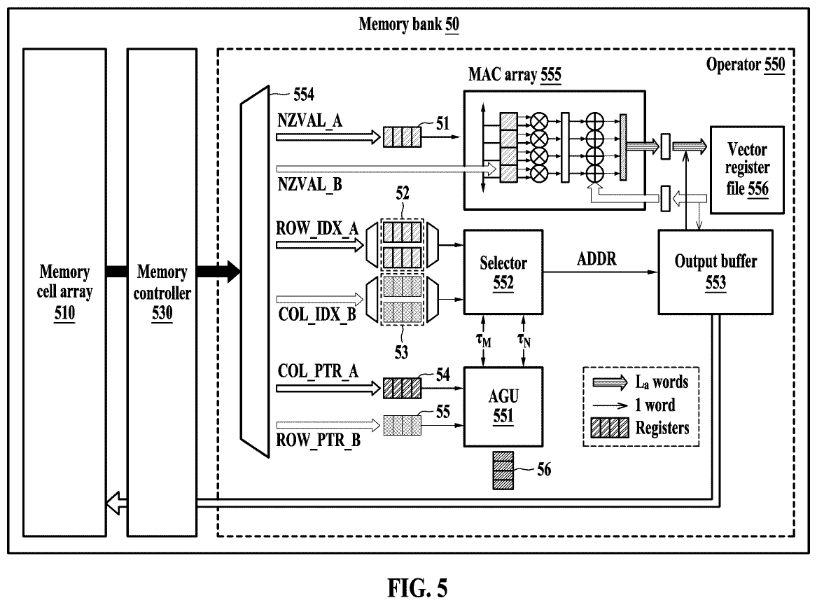

The operators 150, 151, and 152 may accelerate product operations between sparse matrices. The operators 150, 151, and 152 may include configurations including a row buffer for accessing the memory cell arrays 130, 131, and 132 within the memory bank. An example of the operation method of the memory bank including the configurations of the operators 150, 151, and 152 is described in detail with reference to FIG. 5. The memory device 110 may further include a non-transitory computer-readable storage medium storing instructions that, when executed by the host processor 160, configure the host processor 160 to perform any one, any combination, or all of operations and/or methods of the host processor 160.

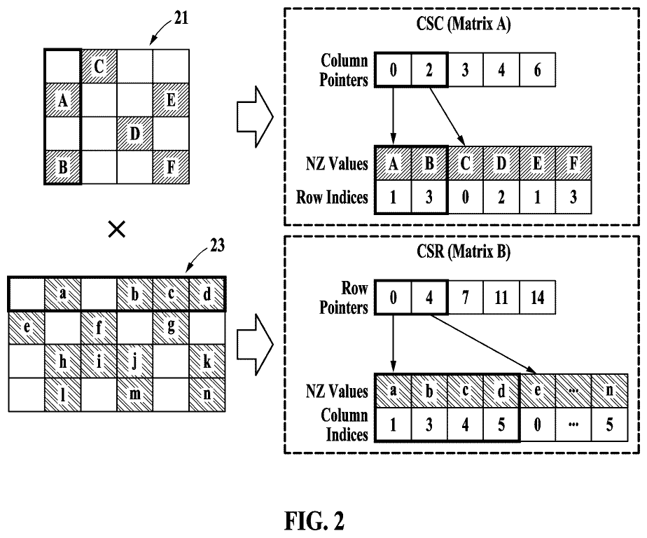

FIG. 2 illustrates an example of a sparse matrix according to one or more embodiments.

The memory system 10 of FIG. 1 may store a first input matrix 21, which is a sparse matrix, in a compressed sparse column (CSC) format.

The CSC format of the first input matrix 21 may include an array of column pointers of the first input matrix 21, an array of non-zero (NZ) values (e.g., A, B, . . . ) of the first input matrix 21, and an array of row index values of the corresponding NZ values. The column pointers of the first input matrix 21 may represent a cumulative number of the NZ values in each column of the first input matrix 21.

The memory system 10 may store a second input matrix 23, which is a sparse matrix, in a compressed sparse row (CSR) format.

The CSR format of the second input matrix 23 may include an array of row pointers of the second input matrix 23, an array of NZ values (e.g., a, b, . . . ) of the second input matrix 23, and an array of column index values of the corresponding NZ values. The row pointers of the second input matrix 23 may represent a cumulative number of the NZ values in each row of the second input matrix 23.

However, the sizes of the first input matrix 21 and the second input matrix 23 shown in FIG. 2 are only examples.

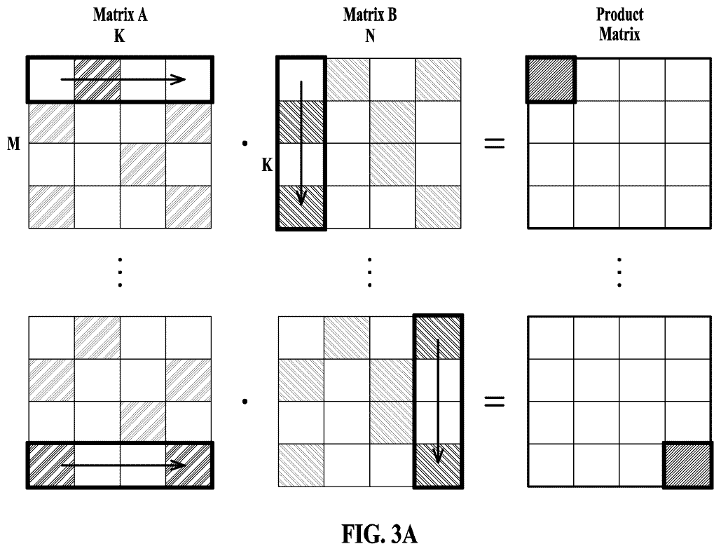

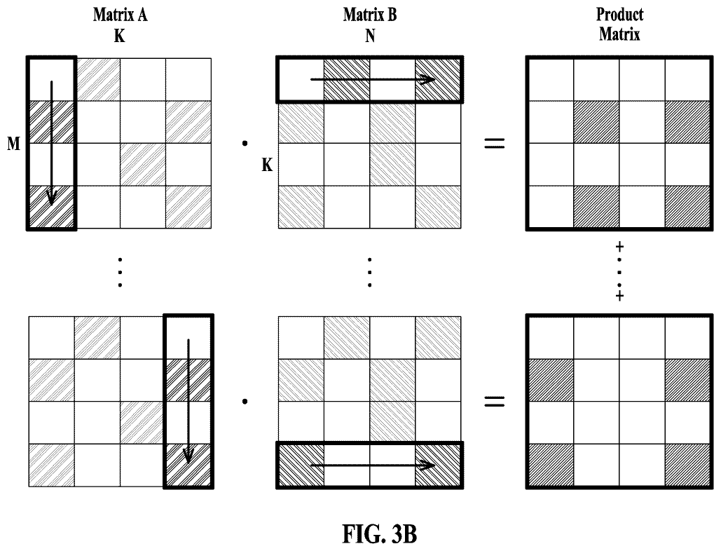

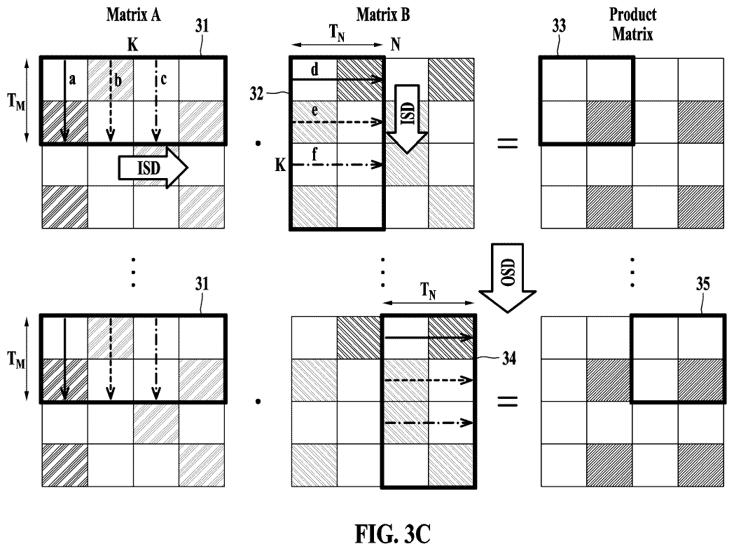

FIGS. 3A and 3B each illustrate an example of a dataflow according to one or more embodiments.

FIG. 3A may correspond to an output-stationary dataflow (OSD) according to an example.

The OSD may be a method of storing partial sums in a register file of multiple operators (e.g., an arithmetic and logical unit (ALU)) to reuse the partial sums.

For example, referring to FIG. 3A, the final operation result through the OSD between a matrix A of size M*K and a matrix B of size K*N may correspond to a combination of operation results according to an inner product of M*N times.

FIG. 3B may correspond to an input-stationary dataflow (ISD) according to an example.

The ISD may be a method of storing an input feature map value in a register file of multiple operators to reuse the input feature map value and transferring weight values to the operators.

For example, referring to FIG. 3B, the final operation result through the ISD between a matrix A of size M*K and a matrix B of size K*N may correspond to an accumulation of operation results according to an outer product of K times.

FIG. 3C illustrates an example of a flexible hybrid dataflow (FHD).

The FHD may be a method of determining an operation result between submatrices of an input matrix A and submatrices of an input matrix B through the ISD and determining a final operation result between operation results between the submatrices through the OSD.

The memory system 10 may partition the first input matrix (e.g., matrix A) and the second input matrix (e.g., matrix B) based on a defined (e.g., predetermined) tile size and may then determine the operation result between partitions of the input matrices through the ISD.

For example, the memory system 10 may determine first submatrices by dividing the first input matrix (e.g., matrix A) by a first size (e.g. τ_{M}) in a row direction to generate the operation results of the defined tile size (e.g., τ_{M}*τ_{N}) and may determine second submatrices by dividing the second input matrix (e.g., matrix B) by a second size (e.g. τ_{N}) in a column direction.

According to an example, an operator (e.g., the operator 150, 151, or 152 of FIG. 1) of a memory bank (e.g., the first memory bank 120, the second memory bank 121, or the third memory bank 122 of FIG. 1) may include a multiply-accumulate (MAC) array (e.g., a MAC array 555 of FIG. 5).

The MAC array may perform outer product and accumulation operations between column vectors of the first size of the first input matrix (e.g., matrix A) and row vectors of the second size of the second input matrix (e.g., matrix B).

For example, referring to FIG. 3C, the MAC array may perform the outer product and accumulation operations between the column vectors of the first size of a first submatrix 31 obtained by dividing the first input matrix (e.g., matrix A) by the first size in the row direction and the row vectors of a second submatrix 32 obtained by dividing the second input matrix (e.g., matrix B) by the second size in the column direction.

The MAC array may perform the outer product operation between a column vector a of the first submatrix 31 and a row vector d of the second submatrix 32. Next, the MAC array may perform the accumulation operation between a previous outer product operation result and an outer product operation result of performing the outer product operation between a column vector b of the first submatrix 31 and a row vector e of the second submatrix 32. The MAC array may perform the accumulation operation between a previous accumulation operation result and an outer product operation result of performing the outer product operation between a column vector c of the first submatrix 31 and a row vector f of the second submatrix 32.

The MAC array may include a plurality of MAC modules (e.g., processing elements (PEs)). The MAC array may perform a product operation between elements of the row vector d of the second submatrix 32 stored in each MAC unit and one element of the column vector a of the first submatrix 31. Therefore, the product operation may be performed between one element of the column vector a of the first submatrix 31 and all elements of the row vector d of the second submatrix 32. Next, the product operation may be performed between one next element of the column vector a of the first submatrix 31 and all elements of the row vector d of the second submatrix 32.

In this method, when the outer product and accumulation operations between the column vectors of the first submatrix 31 of the first input matrix and the row vectors of the second submatrix 32 of the second input matrix are completed, an operation result 33 may be determined. Similarly, when the operations between the column vectors of the first submatrix 31 of the first input matrix and the row vectors of a second submatrix 34 of the second input matrix are completed, an operation result 35 may be determined. A detailed description of the operations between a different first submatrix of the first input matrix and a different second submatrix of the second input matrix is omitted.

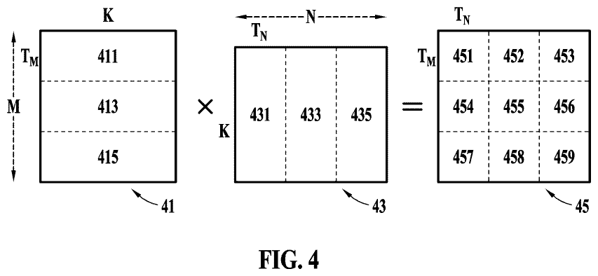

The memory system 10 may determine the final operation result through the OSD between the operation results (e.g., the operation results 33 and 35) between the first submatrices of the first input matrix and the second submatrices of the second input matrix. An example of a method of determining the final operation result is described in detail with reference to FIG. 4.

According to the FHD method, input data may be reused between the submatrices of the input matrix and the submatrices of the input matrix through the ISD. Here, by not performing the entire outer product operation of the input matrices, and instead reusing the input data as described, the memory system 10 of one or more embodiments may advantageously improve processing speed and reduce the required size of an output buffer storing the operation results between the submatrices. In addition, output data may be reused between the operation results between the submatrices through the OSD.

FIG. 4 illustrates an example of a method of performing a matrix product operation for a defined tile size according to one or more embodiments.

The memory system 10 of FIG. 1 may pre-store a defined tile size (e.g., τ_{M}*τ_{N}). The defined tile size may correspond to a first size (e.g. τ_{M}) in a row direction and a second size (e.g. τ_{N}) in a column direction.

The memory system 10 may determine first submatrices 411, 413, and 415 by dividing a first input matrix 41, which is a sparse matrix, by the first size (e.g., τ_{M}) in the row direction.

The first submatrices 411, 413, and 415 may each include column vectors of the first size. For example, when the first input matrix 41 is an M*K matrix, the first submatrices 411, 413, and 415 may each include “K” column vectors of the first size.

The memory system 10 may determine second submatrices 431, 433, and 435 by dividing a second input matrix 43, which is a sparse matrix, by the second size (e.g., τ_{N}) in the column direction.

The second submatrices 431, 433, and 435 may each include row vectors of the second size. For example, when the second input matrix 43 is a K*N matrix, the second submatrices 431, 433, and 435 may each include “K” row vectors of the second size.

In the memory system 10, a matrix product operation may be performed between one of the first submatrices 411, 413, and 415 for the first input matrix 41 and one of the second submatrices 431, 433, and 435 for the second input matrix 43. As a result, operation results 451, 452, 453, 454, 455, 456, 457, 458, and 459 of the defined tile size may be determined.

According to an example, an operation result according to a matrix product between the first input matrix 41 and the second input matrix 43 may be determined as a final operation result 45 that corresponds to a combination of the operation results 451 to 459 according to each matrix product between the first submatrices 411, 413, and 415 and the second submatrices 431, 433, and 435.

Based on an index in the first input matrix 41 of an arbitrary first submatrix on which the matrix product operation is performed and an index in the second input matrix 43 of an arbitrary second submatrix, each operation result may be combined into the final operation result 45.

For example, the operation result 451 may be determined by the matrix product between the first submatrix 411 at a position [0,0] of the first input matrix 41 and the second submatrix 431 at a position [0,0] of the second input matrix 43. The operation result 452 may be determined by the matrix product between the first submatrix 411 at the position [0,0] of the first input matrix 41 and the second submatrix 433 at a position [0,1] of the second input matrix 43. The operation result 459 may be determined by the matrix product between the first submatrix 411 at a position of the first input matrix 41 and the second submatrix 433 at a position [0,2] of the second input matrix 43.

The memory system 10 according to an example may pre-store one of the first submatrices 411, 413, and 415 for the first input matrix 41 and one of the second submatrices 431, 433, and 435 for the second input matrix 43 in the memory cell array of each of the plurality of memory banks (e.g., the first memory bank 120, the second memory bank 121, and the third memory bank 122) of the memory device 110.

Each of the plurality of memory banks of the memory device 110 may determine the operation result according to the matrix product between the first submatrix of the first input matrix 41 and the second submatrix of the second input matrix 43 stored in the memory cell array included in the corresponding memory bank.

For example, the first submatrix 411 and the second submatrix 431 may be stored in the memory cell array 130 of the first memory bank 120. The first memory bank 120 may determine the operation result 451 according to the matrix product between the first submatrix 411 and the second submatrix 431 stored in the memory cell array 130. The first submatrix 411 and the second submatrix 433 may be stored in the memory cell array 131 of the second memory bank 121. The second memory bank 121 may determine the operation result 452 according to the matrix product between the first submatrix 411 and the second submatrix 433 stored in the memory cell array 131.

Each of the plurality of memory banks of the memory device 110 may perform the matrix product operations in parallel to determine the operation result of the defined tile size. The combination of the operation results 451 to 459 of the defined tile size determined in each of the memory banks may correspond to the final operation result 45 between the first input matrix 41 and the second input matrix 43.

According to an example, the host processor 160 of FIG. 1 may determine the final operation result 45 by combining the operation results 451 to 459 of the defined tile size determined in each of the memory banks of the memory device 110.

FIG. 5 illustrates an example of an operation method of a memory device according to one or more embodiments.

A memory device (e.g., the memory device 110 of FIG. 1) according to an example may include a memory bank 50 (e.g., the first memory bank 120, the second memory bank 121, or the third memory bank 122 of FIG. 1). As described with reference to FIG. 1, the memory device may include a plurality of memory banks. The memory bank 50 of FIG. 5 shows an arbitrary memory bank among the memory banks of the memory device, and the following description of the memory bank 50 may be applied to each of the other memory banks of the memory device that is not shown.

Terms, such as “unit,” “module,” etc., used hereinafter may refer to a part for processing a function or an operation and may be implemented as hardware (e.g., hardware implementing software).

The memory bank 50 may include a memory cell array 510 (e.g., the memory cell array 130, 131, or 132 of FIG. 1), a memory controller 530 (e.g., the memory controller 140, 141, or 142 of FIG. 1) and an operator 550 (e.g., the operator 150, 151, or 152 of FIG. 1). In a non-limiting example, the operator 550 may be a processor, a hardware accelerator, a neural processor, and/or an NPU. In a non-limiting example, the memory controller 530 may be a hardware circuit, an MCC, an MCU, and/or an IMC.

As the memory bank 50 includes the memory controller 530 and the operator 550, independent data access to the memory cell array 510 may be implemented within the memory bank 50, and individual operations may be performed in parallel through the memory bank 50 and other memory banks.

The memory controller 530 may control transmission and reception of data between the memory cell array 510 and the operator 550 by generating a command (e.g., read or write).

The operator 550 may accelerate product operations between sparse matrices. The operator 550 may include a row buffer 554 for accessing the memory cell array 510 within the memory bank 50.

When reading data from a specific row of the memory cell array 510, and when a voltage corresponding to each voltage stored in a capacitor of a corresponding cell is transmitted along bit-lines, the row buffer 554 may read the transmitted voltage. The row buffer 554 may be connected to a corresponding one of the bit-lines. The row buffer 554 may store data read from a current row (or page) until the data is erased by a pre-charge command.

A selector 552 may be a device for selecting data corresponding to a row address from among pieces of data stored in the row buffer 554 and may be, for example, a multiplexer. However, the selector 552 is not limited to the multiplexer and may be or include other devices for selecting a certain piece of data from among pieces of data.

The operator 550 may include a plurality of buffers (e.g., a value buffer 51, a first index buffer 52, a second index buffer 53, a first pointer buffer 54, a second pointer buffer 55, and an address buffer 56). Each of the buffers may be an atom buffer. An atom buffer may represent a buffer of a smaller size than a column vector or a row vector obtained from the memory cell array 510 and may be used for efficient operation and memory access. For example, when 128 bits of data are read or written in one access (or column access) to the memory cell array 510, each atom vector may have a size of 128 bits. When the size of one word (or element) is 16 bits, each atom vector may include “128/16=8” words. Hereinafter, each operation may be performed in units of the size (e.g., Lₐ) of the atom vector.

As described with reference to FIG. 2, the memory cell array 510 of the memory bank 50 may store a first input matrix, which is a sparse matrix, in a CSC format. The CSC format of the first input matrix may include an array of column pointers (or first pointers) of the first input matrix, an array of NZ values of the first input matrix, and an array of row index values of the corresponding NZ values. The memory cell array 510 of the memory bank 50 may store a second input matrix, which is a sparse matrix, in a CSR format. The CSR format of the second input row may include an array of row pointers (or second pointers) of the second input matrix, an array of NZ values of the second input matrix, and an array of column index values of the corresponding NZ values. As described with reference to FIG. 4, the memory cell array 510 of the memory bank 50 may store a first submatrix of the first input matrix and a second submatrix of the second input matrix. In summary, the memory cell array 510 of the memory bank 50 may store a portion corresponding to the first submatrix in the CSC format of the first input matrix and a portion corresponding to the second submatrix in the CSR format of the second input matrix.

In FIG. 5, the first input matrix is referenced as “A”, and the second input matrix is referenced as “B”. NZVAL_A may represent an NZ value of the first input matrix, and NZVAL_B may represent an NZ value of the second input matrix. ROW_IDX_A may represent a row index value of the first input matrix, and COL_IDX_B may represent a column index value of the second input matrix. COL_PTR_A may represent a pointer (or a first pointer) of the first input matrix, and ROW_PTR_B may represent a pointer (or a second pointer) of the second input matrix.

The first pointer buffer 54 may store the first pointer of the first input matrix (e.g., COL_PTR_A) received from the memory cell array 510. The second pointer buffer 55 may store the second pointer of the second input matrix (e.g., ROW_PTR_B) received from the memory cell array 510.

An address generation unit (AGU) 551 may store a defined tile size (or a first size and a second size). The AGU 551 may refer to the first pointer and the second pointer respectively stored in the first pointer buffer 54 and the second pointer buffer 55 and thus, may determine and generate addresses of data (or elements) corresponding to the defined tile size to be received from the memory cell array 510. For example, the AGU 551 may generate an address of the memory cell array 510 for loading the row index value including the NZ value of the first input matrix and the column index value including the NZ value of the second input matrix. The AGU 551 may generate the address for loading the NZ values of the first input matrix and the NZ values of the second input matrix. The address buffer 56 may store the addresses of the memory cell array 510 generated by the AGU 551.

The first index buffer 52 may store the row index value including the NZ value of the first input matrix (e.g., ROW_IDX_A) received from the memory cell array 510 based on the first pointer. The second index buffer 53 may store the column index value including the NZ value of the second input matrix (e.g., COL_IDX_B) received from the memory cell array 510 based on the second pointer. The row index value and the column index value may be received based on the addresses stored in the address buffer 56.

The value buffer 51 may store the NZ values of the first input matrix (e.g., NZVAL_A) received from the memory cell array 510. Referring to FIG. 5, the NZ values of the second input matrix (e.g., NZVAL_B) received from the memory cell array 510 may be input to the MAC array 555. The NZ values of the first input matrix and the NZ values of the second input matrix may be received based on the addresses stored in the address buffer 56.

The selector 552 may generate an address in an output buffer 553 in which an operation result between the corresponding NZ values of the first input matrix and the second input matrix is to be stored by the row index value stored in the first index buffer 52 and the column index value stored in the second index buffer 53.

The MAC array 555 may include a plurality of MAC modules (e.g., PEs). The MAC array 555 may fix NZ values of a row vector of the second size of the second input matrix at a MAC unit level of the MAC array 555. The MAC array 555 may perform an outer product operation by broadcasting an NZ value of each row of a column vector of the first size of the first input matrix to the NZ values of the row vector of the second size of the second input matrix fixed at the MAC unit level of the MAC array 555.

For example, a product operation may be performed between one value of the column vector of the first input matrix and all values of the row vector of the second input matrix. Here, the column vector of the first input matrix may represent the column vector of the first submatrix of the first input matrix stored in the memory cell array 510. The row vector of the second input matrix may represent the row vector of the second submatrix of the second input matrix stored in the memory cell array 510.

For example, each value of a first column vector among column vectors of the first input matrix may be transmitted one by one to the MAC array 555 by the value buffer 51. The product operation may be sequentially performed between each of values of the first column vector of a first input vector and all values of a first row vector among row vectors of the second input matrix.

A vector register file 556 may include registers of an atom buffer size. For example, when the size of one word is 16 bits, the vector register file 556 may include “128/16=8” registers of the atom buffer size.

The vector register file 556 may temporarily store a partial operation result determined by the product operation between one value of the first column vector of the first input matrix and all values of the first row vector of the second input matrix. The vector register file 556 may temporarily store partial operation results sequentially determined as the product operation is performed between each of values of the first column vector of the first input vector and all values of the first row vector of the second input matrix.

As a result, the vector register file 556 may temporarily store an outer product operation result operation based on the first row vector and the first column vector (or all values of the first column vector) of the first input matrix of the MAC array 555. The vector register file 556 may transmit the outer product operation result to the output buffer 553.

The output buffer 553 may have the defined tile size corresponding to the first size and the second size. The defined tile size may be preset based on the size of the output buffer 553.

The output buffer 553 may store the operation result (e.g., the outer product operation result or an operation result by an accumulation operation) based on each column vector and row vector of the MAC array 555.

For example, the outer product operation result based on the first column vector and the first row vector of the MAC array 555 may be stored in the output buffer 553. The operation result (or the outer product operation result) based on the first column vector and the first row vector may be referred to as a first operation result.

In response to the operation based on the first column vector and the first row vector being performed, each value of a second column vector, other than the first column vector, among the column vectors of the first input matrix may be transmitted one by one to the MAC array 555 by the value buffer 51. The product operation may be sequentially performed between each of values of the second column vector of the first input vector and all values of a second row vector, other than the first row vector, among the row vectors of the second input matrix.

The MAC array 555 may determine the outer product operation result by performing the outer product operation between the second column vector of the first input matrix and the second row vector of the second input matrix received from the memory cell array 510.

The vector register file 556 may load an existing operation result from the output buffer 553 and may provide the operation result to the MAC array 555 for performing an accumulation operation. For example, the vector register file 556 may load the outer product operation result, which is the first operation result between the first column vector and the first row vector, from the output buffer 553 and may provide the first operation result to the MAC array 555 for performing the accumulation operation.

The MAC array 555 may determine the operation result by performing the accumulation operation between the first operation result obtained from the output buffer 553 through the vector register file 556 and the outer product operation result between the second column vector and the second row vector. The operation result based on the second column vector and the second row vector may be referred to as a second operation result.

The vector register file 556 may temporarily store the second operation result based on the second column vector and the second row vector of the MAC array 555. The vector register file 556 may transmit the second operation result to the output buffer 553.

The output buffer 553 may update the first operation result with the second operation result obtained from the MAC array 555 through the vector register file 556.

The operation results (e.g., a third operation result, a fourth operation result, . . . ) between column vector(s), other than the first column vector and the second column vector, among the column vectors of the first input matrix and row vector(s), other than the first row vector and the second row vector, among the row vectors of the second input matrix may be sequentially determined. The operator 550 may determine an updated operation result by performing the accumulation operation between a previous operation result and the outer product operation result between each column vector of the first input matrix and each row vector of the second input matrix.

The operator 550 may receive a first command from the memory controller 530 based on completion of the operation between the column vectors of the first submatrix of the first input matrix and the row vectors of the second submatrix of the second input matrix in the MAC array 555. The first command may include a write command. When the operator 550 receives the first command from the memory controller 530, the operator 550 may transmit the updated operation result of the defined tile size from the output buffer 553 to the memory cell array 510.

According to an example, not only in a PIM system but also in a process-near-memory (PNM) system, the operation method of the memory device of the present disclosure may be implemented by positioning the operator 550 outside a memory die. The operator 550 may be shared by the memory bank 50 of the memory die so that the operator 550 may perform operations on data stored in the memory die without passing through an external bus.

According to an example, the operation method of the memory device of the present disclosure may be implemented for not only a sparse matrix product but also general matrix-vector multiplication and matrix-matrix multiplication.

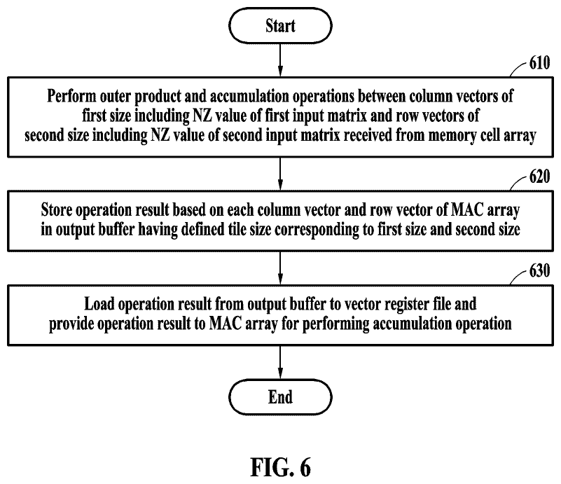

FIG. 6 illustrates an example of an operation method of a memory device according to one or more embodiments.

According to an example, operations 610 to 630 below may be performed by a memory device (e.g., the memory device 110 of FIG. 1). The memory device may include at least some of the components of the memory device described in FIGS. 1 to 5. For example, the memory device may include a plurality of memory banks (e.g., the first memory bank 120, the second memory bank 121, the third memory bank 122 of FIG. 1, and/or the memory bank 50 of FIG. 5). Each of the plurality of memory banks may include a memory cell array (e.g., the memory cell array 130, 131, or 132 of FIG. 1 or the memory cell array 510 of FIG. 5), a memory controller (e.g., the memory controller 140, 141, or 142 of FIG. 1 or the memory controller 530 of FIG. 5), and an operator (e.g., the operator 150, 151, or 152 of FIG. 1 or the operator 550 of FIG. 5).

The operator within the memory bank of the memory device may include a plurality of buffers, an AGU (e.g., the AGU 551 of FIG. 5), a selector (e.g., the selector 552 of FIG. 5), an output buffer (e.g., the output buffer 553 of FIG. 5), a row buffer (e.g., the row buffer 554 of FIG. 5), a MAC array (e.g., the MAC array 555 of FIG. 5), and a vector register file (e.g., the vector register file 556 of FIG. 5).

The plurality of buffers of the operator may include a value buffer (e.g., the value buffer 51 of FIG. 5), a first index buffer (e.g., the first index buffer 52 of FIG. 5), a second index buffer (e.g., the second index buffer 53 of FIG. 5), a first pointer buffer (e.g., the first pointer buffer 54 of FIG. 5), and a second pointer buffer (e.g., the second pointer buffer 55 of FIG. 5).

Although operations 610 to 630 of FIG. 6 are illustrated as being performed sequentially, one or more of the operations may be performed in a different order, one or more of the operations may be omitted, two or more of the operations may be performed in parallel or simultaneously, and/or other operations may be additionally performed without departing from the spirit and scope of the described embodiments.

The memory cell array may store a portion of a first input matrix in a CSC format and a portion of a second input matrix in a CSR format.

The memory cell array may pre-store one of first submatrices obtained by dividing the first input matrix by a first size in a row direction and one of second submatrices obtained by dividing the second input matrix by a second size in a column direction. The first submatrices of the first input matrix may each include column vectors of the first size, and the second submatrices of the second input matrix may each include row vectors of the second size.

In operation 610, the MAC array may perform an outer product and accumulation operation between the column vectors of the first size including NZ values of the first input matrix and the row vectors of the second size including NZ values of the second input matrix received from the memory cell array.

The column vectors of the first size of the first input matrix may represent the column vectors of a first submatrix of the first input matrix stored in the memory cell array. The row vectors of the second input matrix may represent the row vectors of a second submatrix of the second input matrix stored in the memory cell array.

The MAC array may perform an operation based on a first column vector among the column vectors of the first input matrix and a first row vector among the row vectors of the second input matrix.

The MAC array may fix NZ values of a row vector (e.g., the first row vector) of the second size of the second input matrix at a MAC unit level of the MAC array. The MAC array may perform an outer product operation by broadcasting an NZ value of each row of a column vector (e.g., the first column vector) of the first size of the first input matrix to the NZ values of the row vector of the second size of the second input matrix fixed at the MAC unit level.

For example, a product operation may be performed between one value of the column vector of the first input matrix and all values of the row vector of the second input matrix. Each value of the column vector of the first input matrix may be transmitted one by one to the MAC array by a value buffer. The product operation may be sequentially performed between each of values of the column vector of a first input vector and all values of the row vector of the second input matrix.

The vector register file may temporarily store a partial operation result determined by the product operation between one value of the column vector of the first input matrix and all values of the row vector of the second input matrix. The vector register file may temporarily store partial operation results sequentially determined as the product operation is performed between each of values of the column vector of the first input vector and all values of the row vector of the second input matrix.

The vector register file may temporarily store a first operation result operation based on the first row vector and the first column vector (or all values of the first column vector) of the MAC array. The vector register file may transmit the first operation result to an output buffer.

In operation 620, the output buffer may store the operation result based on each column vector and row vector of the MAC array. The output buffer may have a defined tile size corresponding to the first size and the second size. The first operation result based on the first column vector and the first row vector of the MAC array may be stored in the output buffer.

The MAC array may determine an outer product operation result by performing the outer product operation between a second column vector, other than the first column vector, among the column vectors of the first input matrix and a second row vector, other than the first row vector, among the row vectors of the second input matrix received from the memory cell array.

In operation 630, the vector register file may load the operation result from the output buffer and may provide the operation result to the MAC array for performing an accumulation operation. For example, the vector register file may load the first operation result from the output buffer and may provide the first operation result to the MAC array for performing the accumulation operation.

The MAC array may determine a second operation result by performing the accumulation operation between the outer product operation result and the first operation result obtained from the output buffer through the vector register file.

The vector register file may temporarily store the second operation result based on the second column vector and the second row vector of the MAC array. The vector register file may transmit the second operation result to the output buffer.

The output buffer may update the first operation result with the second operation result obtained from the MAC array through the vector register file.

The above-described operation results (e.g., the first operation result, the second operation result, and the outer product operation result) may have the defined tile size. The MAC array may determine an updated operation result by performing the accumulation operation between a previous operation result and the outer product operation result between each column vector of the first input matrix and each row vector of the second input matrix received from the memory cell array.

When the operator receives a first command from the memory controller based on completion of the operation between the column vectors of the first submatrix of the first input matrix and the row vectors of the second submatrix of the second input matrix in the MAC array, the operator may transmit the updated operation result of the defined tile size from the output buffer to the memory cell array. The first command may include a write command.

Each of the plurality of memory banks of the memory device may perform operations in parallel to determine the updated operation result of the defined tile size between one of the first submatrices of the first size of the first input matrix and one of the second submatrices of the second size of the second input matrix.

A combination of the updated operation results of the defined tile size determined in each of the memory banks may correspond to a final operation result between the first input matrix and the second input matrix. The final operation result may be in a dense matrix format.

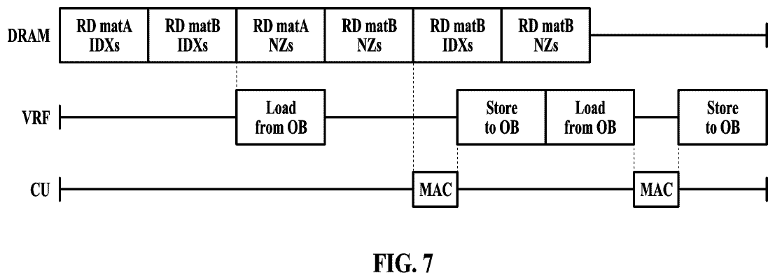

FIG. 7 illustrates an example of a method of performing a MAC operation and receiving a column index value, in an overlapping manner according to one or more embodiments.

As described above, a first pointer buffer may store a first pointer of a first input matrix received from a memory cell array. A second pointer buffer may store a second pointer of a second input matrix received from the memory cell array.

A first index buffer may store a row index value including an NZ value of the first input matrix received from the memory cell array based on the first pointer. A second index buffer may store a column index value including an NZ value of the second input matrix received from the memory cell array based on the second pointer.

A value buffer may store NZ values of the first input matrix received from the memory cell array. NZ values of the second input matrix received from the memory cell array may be input to a MAC array.

The MAC array may perform an operation based on a first column vector among column vectors of the first input matrix and a first row vector among row vectors of the second input matrix.

The second index buffer may receive the column index value corresponding to a second row vector, different from the first row vector, among the row vectors of the second input matrix from the memory cell array, while the operation based on the first column vector and the first row vector is performed in the MAC array.

The memory systems, memory devices, first memory banks, second memory banks, third memory banks, memory cell arrays, memory controllers, operators, memory banks, value buffers, first index buffers, second index buffers, first pointer buffers, second pointer buffers, address buffers, AGUs, selectors, output buffers, row buffers, MAC arrays, vector register files, memory system 10, memory device 110, first memory bank 120, second memory bank 121, third memory bank 122, memory cell array 130, memory controller 140, operator 150, memory cell array 131, memory controller 141, operator 151, memory cell array 132, memory controller 142, operator 152, memory bank 50, value buffer 51, first index buffer 52, second index buffer 53, first pointer buffer 54, second pointer buffer 55, address buffer 56, memory cell array 510, memory controller 530, operator 550, AGU 551, selector 552, output buffer 553, row buffer 554, MAC array 555, and vector register file 556 described herein, including descriptions with respect to respect to FIGS. 1-7, are implemented by or representative of hardware components. As described above, or in addition to the descriptions above, examples of hardware components that may be used to perform the operations described in this application where appropriate include controllers, sensors, generators, drivers, memories, comparators, arithmetic logic units, adders, subtractors, multipliers, dividers, integrators, and any other electronic components configured to perform the operations described in this application. In other examples, one or more of the hardware components that perform the operations described in this application are implemented by computing hardware, for example, by one or more processors or computers. A processor or computer may be implemented by one or more processing elements, such as an array of logic gates, a controller and an arithmetic logic unit (ALU), a digital signal processor (DSP), a microcomputer, a programmable logic controller, a field-programmable gate array (FPGA), a programmable logic array (PLU), a microprocessor, or any other device or combination of devices that is configured to respond to and execute instructions (e.g., code or coding) in a defined manner to achieve a desired result. In one example, a processor or computer includes, or is connected to, one or more memories storing the instructions or software that are executed by the processor or computer. Hardware components implemented by a processor or computer may execute the instructions or software, such as an operating system (OS) and one or more software applications that run on the OS, to perform the operations described in this application. The hardware components may also access, manipulate, process, create, and store data in response to execution of the instructions or software. For simplicity, the singular term “processor” or “computer” may be used in the description of the examples described in this application, but in other examples multiple processors or computers may be used, or a processor or computer may include multiple processing elements, or multiple types of processing elements, or both, and thus while some references may be made to a singular processor or computer, such references also are intended to refer to multiple processors or computers. For example, a single hardware component or two or more hardware components may be implemented by a single processor, or two or more processors, or a processor and a controller. One or more hardware components may be implemented by one or more processors, or a processor and a controller, and one or more other hardware components may be implemented by one or more other processors, or another processor and another controller. One or more processors, or a processor and a controller, may implement a single hardware component, or two or more hardware components. As described above, or in addition to the descriptions above, example hardware components may have any one or more of different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing. Thus, references to a processor herein mean processing circuitry (e.g., circuitry that includes one or more processing element(s) circuits). One or more processors comprising processing circuitry also refers to each processor comprising processing circuitry, as well as some or all of the one or more processors comprising the same processing circuitry. In addition, processors(s) and controller(s), as a non-limiting example, do not mean human processing or human control, but rather, refer to hardware components as described herein, as non-limiting examples.

The methods illustrated in, and discussed with respect to, FIGS. 1-7 that perform the operations described in this application are performed by computing hardware, for example, by one or more processors or computers, implemented as described above implementing the instructions (e.g., computer or processor/processing device readable instructions) or software to perform the operations described in this application that are performed by the methods. For example, a single operation or two or more operations may be performed by a single processor, or two or more processors, or a processor and a controller. One or more operations may be performed by one or more processors, or a processor and a controller, and one or more other operations may be performed by one or more other processors, or another processor and another controller. One or more processors, or a processor and a controller, may perform a single operation, or two or more operations. References to a processor, or one or more processors, as a non-limiting example, configured to perform two or more operations refers to a processor or two or more processors being configured to collectively perform all of the two or more operations, as well as a configuration with the two or more processors respectively performing any corresponding one of the two or more operations (e.g., with a respective one or more processors being configured to perform each of the two or more operations, or any respective combination of one or more processors being configured to perform any respective combination of the two or more operations). Likewise, a reference to a processor-implemented method is a reference to a method that is performed by one or more processors or other processing or computing hardware of a device or system.

The instructions or software to control computing hardware, for example, one or more processors or computers, to implement the hardware components and perform the methods as described above may be written as computer programs, code segments, or other executable instructions or any combination thereof, for individually or collectively instructing or configuring the one or more processors or computers to operate as a machine or special-purpose computer to perform the operations that are performed by the hardware components and the methods as described above. In one example, the instructions or software include machine code that is directly executed by the one or more processors or computers, such as machine code produced by a compiler. In another example, the instructions or software includes higher-level code that is executed by the one or more processors or computer using an interpreter. The instructions or software may be written using any programming language based on the block diagrams and the flow charts illustrated in the drawings and the corresponding descriptions herein, which disclose algorithms for performing the operations that are performed by the hardware components and the methods as described above.

The instructions or software to control computing hardware, for example, one or more processors or computers, to implement the hardware components and perform the methods as described above, and any associated data, data files, and data structures, may be recorded, stored, or fixed in or on one or more non-transitory computer-readable storage media, and thus, not a signal per se. Thus, references herein to storage media mean storage media hardware, and does not mean transitory media, nor a signal per se. As described above, or in addition to the descriptions above, examples of a non-transitory computer-readable storage medium include one or more of any of read-only memory (ROM), random-access programmable read only memory (PROM), electrically erasable programmable read-only memory (EEPROM), random-access memory (RAM), dynamic random access memory (DRAM), static random access memory (SRAM), flash memory, non-volatile memory, CD-ROMs, CD-Rs, CD+Rs, CD-RWs, CD+RWs, DVD-ROMs, DVD-Rs, DVD+Rs, DVD-RWs, DVD+RWs, DVD-RAMs, BD-ROMs, BD-Rs, BD-R LTHs, BD-REs, blue-ray or optical disk storage, hard disk drive (HDD), solid state drive (SSD), flash memory, a card type memory such as a multimedia card or a micro card (for example, secure digital (SD) or extreme digital (XD)), magnetic tapes, floppy disks, magneto-optical data storage devices, optical data storage devices, hard disks, solid-state disks, and/or any other device that is configured to store the instructions or software and any associated data, data files, and data structures in a non-transitory manner and provide the instructions or software and any associated data, data files, and data structures to one or more processors or computers so that the one or more processors or computers can execute the instructions. In one example, the instructions or software and any associated data, data files, and data structures are distributed over network-coupled computer systems so that the instructions and software and any associated data, data files, and data structures are stored, accessed, and executed in a distributed fashion by the one or more processors or computers.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents.

Therefore, in addition to the above and all drawing disclosures, the scope of the disclosure is also inclusive of the claims and their equivalents, i.e., all variations within the scope of the claims and their equivalents are to be construed as being included in the disclosure.

What is claimed is:

1. A memory device comprising:
a memory bank comprising:
a memory cell array;
a memory controller; and
an operator,
wherein the operator comprises:
a multiply-accumulate (MAC) array configured to perform outer product and accumulation operations between column vectors of a first size including non-zero (NZ) values of a first input matrix and row vectors of a second size including NZ values of a second input matrix received from the memory cell array;
an output buffer configured to store an operation result based on each column vector and row vector of the MAC array, wherein the output buffer has a predetermined tile size corresponding to the first size and the second size; and
a vector register file configured to load the operation result from the output buffer and provide the operation result to the MAC array for performing an accumulation operation.

2. The memory device of claim 1, wherein
in response to an operation based on a first column vector among the column vectors of the first input matrix and a first row vector among the row vectors of the second input matrix being completed in the MAC array, a first operation result based on the first column vector and the first row vector is stored in the output buffer,
the MAC array is configured to determine an outer product operation result by performing an outer product operation between a second column vector, other than the first column vector, among the column vectors of the first input matrix and a second row vector, other than the first row vector, among the row vectors of the second input matrix received from the memory cell array and determine a second operation result by performing an accumulation operation between the first operation result and the outer product operation result, wherein the first operation result is generated from the output buffer through the vector register file, and
the output buffer is configured to update the first operation result with the second operation result generated from the MAC array through the vector register file.

3. The memory device of claim 1, wherein the operator is configured to transmit, in response to receiving a first command from the memory controller based on completion of operations between the column vectors and the row vectors in the MAC array, an updated operation result of the predetermined tile size from the output buffer to the memory cell array.

4. The memory device of claim 1, wherein
the memory device comprises a plurality of memory banks,
a memory cell array of each of the plurality of memory banks is configured to pre-store one of first submatrices generated by dividing the first input matrix by the first size in a row direction and one of second submatrices generated by dividing the second input matrix by the second size in a column direction, and
the first submatrices of the first input matrix each comprise the column vectors of the first size and the second submatrices of the second input matrix each comprise the row vectors of the second size.

5. The memory device of claim 4, wherein each of the plurality of memory banks is configured to perform operations in parallel to determine an updated operation result of the predetermined tile size between one of the first submatrices of the first size of the first input matrix and one of the second submatrices of the second size of the second input matrix.

6. The memory device of claim 5, wherein a combination of updated operation results of the predetermined tile size determined in each of the plurality of memory banks corresponds to a final operation result between the first input matrix and the second input matrix.

7. The memory device of claim 1, wherein the MAC array is configured to broadcast an NZ value of each row of the column vector of the first size of the first input matrix to NZ values of the row vector of the second size of the second input matrix fixed at a MAC unit level to perform the outer product operation.

8. The memory device of claim 1, wherein the memory cell array is configured to store a portion of the first input matrix in a compressed sparse column (CSC) format and a portion of the second input matrix in a compressed sparse row (CSR) format.

9. The memory device of claim 1, wherein the operator further comprises:
a first pointer buffer configured to store a first pointer of the first input matrix received from the memory cell array;
a second pointer buffer configured to store a second pointer of the second input matrix received from the memory cell array;
a first index buffer configured to store a row index value including NZ values of the first input matrix received from the memory cell array based on the first pointer;
a second index buffer configured to store a column index value including NZ values of the second input matrix received from the memory cell array based on the second pointer; and
a value buffer configured to store NZ values of the first input matrix received from the memory cell array.

10. The memory device of claim 9, wherein, while the MAC array performs an operation based on a first column vector of the first size of the first input matrix and a first row vector of the second size of the second input matrix, the second index buffer is configured to receive the column index value corresponding to a second row vector, different from the first row vector, of the second input matrix from the memory cell array.

11. A method comprising:
performing outer product and accumulation operations between column vectors of a first size including non-zero (NZ) values of a first input matrix and row vectors of a second size including NZ values of a second input matrix received from a memory cell array;
storing an operation result based on each column vector and row vector of a multiply-accumulate (MAC) array in an output buffer, wherein the output buffer has a predetermined tile size corresponding to the first size and the second size; and
loading the operation result from the output buffer to a vector register file and providing the operation result to the MAC array for performing an accumulation operation.

12. The method of claim 11, wherein the performing of the outer product and accumulation operations between the column vectors of the first size including the NZ values of the first input matrix and the row vectors of the second size including the NZ values of the second input matrix received from the memory cell array comprises:
performing an operation based on a first column vector among the column vectors of the first input matrix and a first row vector among the row vectors of the second input matrix by the MAC array, wherein a first operation result based on the first column vector and the first row vector is stored in the output buffer;
determining, by the MAC array, an outer product operation result by performing an outer product operation between a second column vector, other than the first column vector, among the column vectors of the first input matrix and a second row vector, other than the first row vector, among the row vectors of the second input matrix received from the memory cell array; and
determining, by the MAC array, a second operation result by performing an accumulation operation between the first operation result and the outer product operation result, wherein the first operation result is generated from the output buffer through the vector register file, and wherein the output buffer is configured to update the first operation result with the second operation result generated from the MAC array through the vector register file.

13. The method of claim 11, further comprising, in response to receiving a first command from a memory controller based on completion of the operation between the column vectors and the row vectors in the MAC array, transmitting an updated operation result of the predetermined tile size from the output buffer to the memory cell array.

14. The method of claim 11, further comprising pre-storing, by a memory cell array of each of a plurality of memory banks, one of first submatrices generated by dividing the first input matrix by the first size in a row direction and one of second submatrices generated by dividing the second input matrix by the second size in a column direction,
wherein the first submatrices of the first input matrix each comprise the column vectors of the first size and the second submatrices of the second input matrix each comprise the row vectors of the second size.

15. The method of claim 14, further comprising performing operations in parallel using each of the plurality of memory banks to determine an updated operation result of the predetermined tile size between one of the first submatrices of the first size of the first input matrix and one of the second submatrices of the second size of the second input matrix.

16. The method of claim 15, wherein a combination of updated operation results of the predetermined tile size determined in each of the plurality of memory banks corresponds to a final operation result between the first input matrix and the second input matrix.

17. The method of claim 11, wherein an NZ value of each row of the column vector of the first size of the first input matrix is broadcasted to NZ values of the row vector of the second size of the second input matrix fixed at a MAC unit level by the MAC array to perform the outer product operation.

18. The method of claim 11, further comprising storing, using the memory cell array, a portion of the first input matrix in a compressed sparse column (CSC) format and a portion of the second input matrix in a compressed sparse row (CSR) format.

19. The method of claim 11, further comprising:
storing, using a first pointer buffer, a first pointer of the first input matrix received from the memory cell array;
storing, using a second pointer buffer, a second pointer of the second input matrix received from the memory cell array;
storing, using a first index buffer, a row index value including NZ values of the first input matrix received from the memory cell array based on the first pointer;
storing, using a second index buffer, a column index value including NZ values of the second input matrix received from the memory cell array based on the second pointer;
storing, using a value buffer, NZ values of the first input matrix received from the memory cell array; and
while the MAC array performs an operation based on a first column vector of the first size of the first input matrix and a first row vector of the second size of the second input matrix, receiving the column index value corresponding to a second row vector, different from the first row vector, of the second input matrix from the memory cell array.

20. A method comprising:
generating first submatrices by dividing a first input matrix by a first size in a row direction;
generating second submatrices by dividing a second input matrix by a second size in a column direction;
performing, for each element of a column vector of a first submatrix of the first submatrices, a product operation between the element of the column vector and each element of a corresponding row vector of a second submatrix of the second submatrices; and
based on results of the product operations, generating a final operation result by performing, for each of the first submatrices, outer product and accumulation operations between column vectors of the first submatrix and row vectors of each of the second submatrices.
